(19) United States
(12) Patent Application Publication
(10) Pub. No.: US 2009/0254705 A1
(43) Pub. Date: Oct. 8, 2009

(54) BUS ATTACHED COMPRESSED RANDOM ACCESS MEMORY

(75) Inventors: Bulent Abali, Tenafly, NJ (US); John P. Karidis, Ossining, NY (US); Luis A. Lastras-Montano, Cortlandt Manor, NY (US)

Correspondence Address: SCULLY, SCOTT, MURPHY & PRESSER, P.C., 400 GARDEN CITY PLAZA, SUITE 300, GARDEN CITY, NY, 11530, US

(73) Assignee: INTERNATIONAL BUSINESS MACHINES CORPORATION, Armonk, NY (US)

(21) Appl. No.: 12/098,900

(22) Filed: Apr. 7, 2008

(51) Int. Cl. G06F 12/08

(52) U.S. Cl. 711/117; 711/E12.016

(57) ABSTRACT

A computer memory system having a three-level memory hierarchy structure is disclosed. The system includes a memory controller, a volatile memory, and a non-volatile memory. The volatile memory is divided into an uncompressed data region and a compressed data region.

### BACKGROUND OF THE INVENTION

1. Fields of the Invention

The present invention generally relates to a memory system for a computer. More particularly, the present invention relates to an improved system and method of controlling I/O access to a memory system for a computing device that includes a more cost-effective and more efficient multi-level (e.g., three-level) hierarchical memory structure comprising an uncompressed data region in a volatile memory, a compressed data region in the volatile memory, and a non-volatile memory.

2. Description of the Prior Art

In current computing system memory configurations, an effective size of a Random Access Memory (RAM) is doubled by implementing data compression. However, when the data in a RAM does not compress as much as expected, then excess data needs to be handled by software, for example by writing the excess to a disk, deleting some data in the RAM, and so on. The software for supporting the compression complicates an operating system support and maintenance.

Avraham et al. (US Pre-Grant Publication No. 2005/0027928A1) discloses a memory device including: (a) a first die on which is fabricated a first memory; and (b) a second die on which are fabricated: (i) a controller for the first memory, and (ii) at least one additional component. The first memory is a nonvolatile memory such as flash memory. One of the additional components is a second memory. The second memory is a volatile memory such as SDRAM (Synchronous Dynamic Random Access Memory).

Zilberman (US Pre-Grant Publication No. 2002/0124129A1) discloses a method and a system for improving read and write performance of flash-based storage system, using a plurality of RAM buffer with multiple accesses. An increase of read and write performance of flash-based storage system is achieved by performing a data transfer operation from RAM and to RAM simultaneously.

Petersen et al. (US Pre-Grant Publication No. 2006/0212645A1) discloses a mass storage device having at least one flash memory device and DRAM or SRAM-based cache within a package, and which comprises co-processor means within the package for performing compression of cached data before writing the cached data to the flash memory device and performing decompression of data read from flash memory device.

A non-patent literature entitled “Data Compression with Restricted Parsings” by Peter A. Franaszek, et al., DCC, Proceeding of the Data Compression Conference, Pages: 203-212, 2006, IEEE Computer Society, discloses a hardware-based high-bandwith data compression technique that utilizes data parsing. Another non-patent literature entitled “Algorithms and data structures for compressed-memory machines” by P. A. Franazek, et al., Volume 45, Number 2, 2001, Technology for xSeries Servers, IBM Journal of Research and Development, discusses numerous algorithms and data structures for data compression.

None of these references address solutions for ameliorating software overhead and extra-processing required in current computer memory systems.

### SUMMARY OF THE INVENTION

The present invention is directed to provide a system and method that eliminates problems (e.g., complicating an operating system support and maintenance), caused by a traditional compressed memory, by integrating a low cost memory, e.g., a flash memory device, in to the more expensive RAM. In addition, the present invention provides a memory controller to manage data exchange between a computer system (e.g., a CPU) and memory devices (e.g., DRAM, Flash memory). Moreover, the present invention eliminates the software and associated processing overhead necessary to manage data communication between a computer system (e.g., CPU) and memory devices (e.g., DRAM, Flash memory).

It is therefore an object of the present invention to provide a system having a multi-level, e.g., a three-level, hierarchical memory structure including an uncompressed data region in a Random Access Memory (RAM), a compressed data region in the RAM, and a non-volatile memory.

In one embodiment, there is provided a computer memory system having a multi-level hierarchical memory structure, the computer memory system comprising:

a first-type memory being a volatile memory and having a uncompressed data region (L3) and a compressed data region (L4);

a second-type memory (L5) being an non-volatile memory, being slower than the first-type memory, having more capacity than the first-type memory, and storing compressed data; and

a memory controller means for controlling a direct I/O access to the first-type memory and the second-type memory, for controlling data exchange between the first-type memory and the second-type memory (L5) in response to an issuance of a memory access request from a general purpose processor, and for controlling data exchange between the uncompressed data region (L3) and the compressed data region (L4) in the first-type memory according to an issuance of a memory accesses request from the general purpose processor.

The present invention requires no change to the computer's operating system nor to a configuration application, because a memory controller that supports data compression and decompression has direct access to a volatile memory and to a non-volatile memory to handle data transfer between them.

### BRIEF DESCRIPTION OF THE DRAWINGS

The accompanying drawings are included to provide a further understanding of the present invention, and are incorporated in and constitute a part of this specification. The drawings illustrate embodiments of the invention and, together with the description, serve to explain the principles of the invention. In the drawings,

FIG. 1 illustrates a memory system architecture according to one embodiment of the present invention.

FIG. 2 illustrates a read and write operation flow chart depicting a computer implemented method of the present invention.

### DETAILED DESCRIPTION

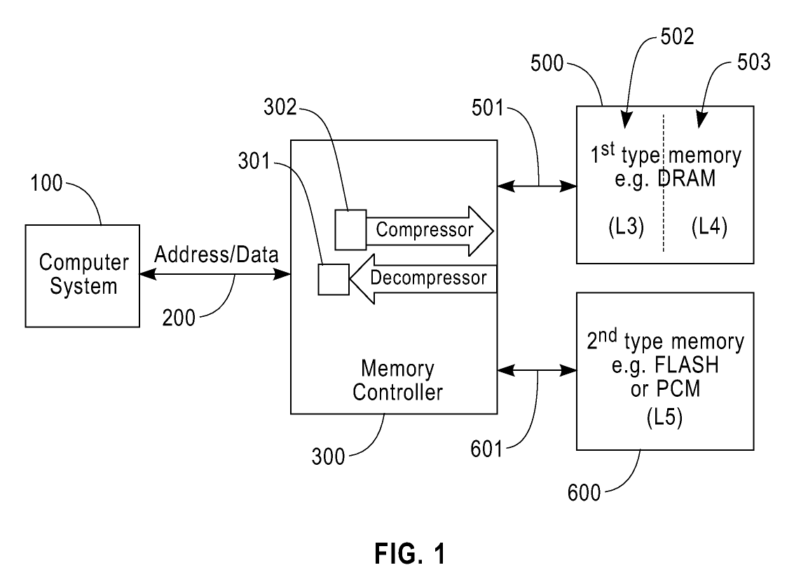

FIG. 1 depicts a block diagram depicting the memory system of the present invention. A computer system 100 such as a general purpose processor (e.g., IBM® Power-PC® Processor) communicates with a memory controller 300 via an address/data bus 200. The system further includes two memory storage devices, a first-type memory 500 having an uncompressed data region 502 (L3) and a compressed data region 503 (L4) and a second-type memory 600 (L5). In one embodiment, the first-type memory 500 is faster and more expensive than the second type memory 600. In this embodiment, the first-type memory 500 has less memory storage capacity than the second-type memory 600. The first-type memory 500 may be volatile memory such as Dynamic Random Access Memory (DRAM) and Static Random Access Memory (SRAM). The second-type memory 600 may be non-volatile memory such as NAND-based flash memory, NOR-based flash memory, Phase Change Memory (PCM), Ferroelectric RAM (FeRAM), and Magnetoresistive RAM (MRAM). In one embodiment, the first-type memory 500 is augmented with a battery (not shown) or an energy storage device (not shown). Thus, in an event of a power loss, the battery device still enable certain memory operations such as copying data stored in the first-type memory 500 into the second-type memory 600. The first-type memory 500 and the second-type memory 600 are operatively coupled to the memory controller 300 via respective address/data buses 501, 601 respectively. In one embodiment, the computer system 100 the memory controller 300, the first-type memory 500, and the second-type memory 600 may be placed on a circuit carrier or a printed circuit board. The circuit carrier or printed circuit board may include at least one processor socket for a single processing system (e.g., Intel® Pentium®, IBM® Power-PC®, etc.) or a multiprocessing system (e.g., symmetric multiprocessor or heterogeneous multiprocessor). In one embodiment, the circuit carrier or printed circuit board further comprises a socket for a memory module (e.g., Dual In-line Memory Module (DIMM), Single In-line Memory Module (SIMM)). In another embodiment, the memory controller 300, the first-type memory 500, and the second-type memory 600 may be encapsulated in a memory module (e.g., DIMM, SIMM) and plugged in the memory module socket on the circuit carrier or printed circuit board. In the other embodiment, the first-type memory 500 and the second-type memory 600 are placed in the circuit carrier or printed circuit board in the form of a solid-state drive (S SD). In one embodiment, the computer system may be a single processing system (e.g., Intel® Pentium®, IBM® Power-PC®), a symmetric multiprocessing system (e.g., Intel®) Core® 2, AMD®, Athlon® 64X2, IBM® Cell® processor) or a heterogeneous multiprocessing system. However, other computing system architectures (e.g., a quantum computer) are contemplated. The address/data bus such as address/data bus 200 is used to transfer addresses and data (e.g., between the computer system 100 and memory controller 300). Further, address/data buses 501 and 601 respectively transfer addresses and data between memory storage devices 500, 600 and the memory controller 300. In one embodiment, each address/data bus may include a HyperTransport (HT) technology, PCI (Peripheral Component Interface) Express, InfiniBand, an industry standard I/O technology (e.g., ISA (Industry Standard Architecture) Bus, USB (Universal Serial Bus), SPI (System Packet Interface), RapidIO, EISA Bus, VL Bus, PCMCIA (Personal Computer Memory Card International Association), CardBus, Micro Channel, AGP (Accelerated Graphic Port), Intelligent-IO, SMBus (System Management Bus), etc.), and/or a non-industry standard I/O technology (e.g., FlexIO® by Rambus®). In one embodiment, each address/data bus operates from 200 MHz to 2.6 GHz, sends and receives data at both rising and falling edges of a clock signal (not shown), has two 2-bit lines to 32-bit lines, and transfers data at 20.8 GB/s. The memory controller 300 manages a placement and movement of data between the computer system 100 and the first-type memory 500 and the second-type memory 600.

In one embodiment, the memory controller 300 is a customized memory controller designed on FPGA (Field-Programmable Gate Array), CPLD (Complex Programmable Logic Device), or ASIC (Application Specific Integrated Circuit), and includes a data compressor 302 and a data decompressor 301. The compressor 302 and decompressor 301 can adopt any data compression/decompression algorithm. For example, Jacob Ziv and Abraham Lempel discloses a sequential data compression algorithm at “A Universal Algorithm for Sequential Data Compression” (IEEE Transaction on Information Theory, Vol. IT-23, No. 3, May 1977) (hereinafter LZ77). R. B. Tremaine et al. discloses a hardware-based memory compressor and decompressor at “IBM Memory Expansion Technology (MXT)” (IBM Research and Development Journal, Vol. 45, No. 2, March 2001) (hereinafter MXT). The whole contents of each of LZ77 and MXT are incorporated herein by a reference.

As further shown in FIG. 1, the first-type memory 500 is logically divided into an uncompressed data region 502 (L3), and a compressed data region 503 (L4). In one embodiment, a dividing boundary between the uncompressed data region 502 (L3) and the compressed data region 503 (L4) is fixed. In one non-limiting example, ⅛ of total capacity in the first-type memory 500 is allocated to the uncompressed data region 502 (L3), and ⅞ of total capacity in the first-type memory 500 is allocated to the compressed data region 503 (L4). In another non-limiting example embodiment, the dividing boundary between the uncompressed data region 502 (L3) and the compressed data region 503 (L4) is dynamically adjusted depending on a compressibility of data in the first-type memory 500. Such dynamic compressibility of data in the first-type memory 500 dynamically renders a size of the uncompressed data region 502 (L3) between 0 and a maximum capacity of the first-type memory 500, and a size of the compressed data region 503 (L4) between 0 and a maximum capacity of the first-type memory 500. In one embodiment, the most frequently used data are stored in the uncompressed data region 502 (L3). What are deemed as the “next” most frequently used data are compressed and then stored in the compressed data region 503 (L4). The least frequently used data are compressed and then stored in the second-type memory 600 (L5).

In one embodiment, via a programmed logic, the memory controller 300 controls a direct I/O access to the first-type memory 500 and the second-type memory 600 via respective address/data buses 501, 601 without involvement of the computer system 100. In another embodiment, the memory controller 300 operates to exchange the data between the first-type memory 500 and the second-type memory 600 without involvement of the computer system 100 (e.g., a general purposes processor). When a memory access request (i.e., an address and/or data; reading data to or writing data from a specified memory address) is sent from the computer system 100 over the address/data bus 200 to the memory controller 300, a logic contained in the memory controller 300 determines whether the specified address issued via the bus 200 exists in the first-type memory 500 or the second-type memory 600. The memory controller 300, in response, then routes the access request (read or write) to the memory containing the address. Furthermore, in accordance with the present invention, the memory controller 300 operates to change a location of an address from the first-type memory 500 to the second-type memory 600, and vice versa.

In another embodiment, the uncompressed data region 502 (L3) stores a cached copy of a portion of the compressed data region 503 (L4). When there is no available space in the uncompressed data region 502 (L3), some or all data in the uncompressed data region 502 (L3) are compressed and written to the compressed data region 503 (L4) to make additional space available in the uncompressed data region 502 (L3). In such operations, the memory controller 300 determines what to compress and what not to compress when moving data between the uncompressed data region 502 (L3) and the compressed data region 503 (L4). In one embodiment, the memory controller 300 utilizes a usage-based replacement algorithm by managing usage histories of memory blocks so that most recently used blocks and least recently used blocks can be separately identified. For example, as least recently used blocks are generally accessed less often than most recently accessed blocks, the least recently used blocks are candidates for compression and therefore the memory controller 300 operates to move the least recently used blocks from the uncompressed data region 502 (L3) to the compressed data region 503 (L4) after compressing when there is no available space in the uncompressed data region 502 (L3). In another embodiment, the memory controller 300 may utilize non-usage-based replacement algorithm (e.g., FIFO, random) when moving data between the uncompressed data region 502 (L3) and the compressed data region 503 (L4). If an address of data requested by a computer system 100 is absent in the uncompressed data region 502 (L3), then the address is searched in the compressed data region 503 (L4) and the requested data is retrieved from the compressed data region 503 (L4) when the address is found in the compressed data region 503 (L4). The retrieved data from the compressed data region 503 (LA) is decompressed and is provided to the computer system 100, while the decompressed data is written to an available memory location of the uncompressed data region 502 (L3) with the address. If an address of data requested by a computer system 100 is absent in the uncompressed data region 502 (L3) and absent in the compressed data region 503 (L4), then the requested data is retrieved from the second-type memory 600 (L5) when the address is found in the second-type memory 600 (L5). The retrieved data from the second-type memory 600 (L5) is decompressed (i.e., the second-type memory 600 includes compressed data), while the retrieved data, which is compressed, is written to an available memory location in the compressed data region 503 (L4) with the address. Then, the decompressed data is written to an available memory location in the uncompressed data region 502 (L3) with the address, while the decompressed data is provided to the computer system 100. In one embodiment, the second-type memory 600 (L5) includes uncompressed data. In another embodiment, the first-type memory 500 stores a cached copy of a portion of the second-type memory 600 (L5). In the absence of available space in the first-type memory 500, some or all data in the first-type memory 500 is written to the second-type memory 600 (L5), after being compressed, to make available spaces in the first-type memory 500. The memory controller 300 determines which memory blocks are moved between the first-type memory 500 and the second-type memory 600. In one embodiment, the memory controller 300 utilizes a usage-based replacement algorithm by managing usage histories of memory blocks so that most recently used blocks and least recently used blocks can be separately identified. Least recently used blocks generally accessed less often than most recently accessed blocks are candidates for moving (e.g., from the first-type memory 500 to the second-type memory 600) and therefore the memory controller 300 moves the least recently used blocks from the first-type memory 500 to the second-type memory 600 when there is no available space in the first-type memory 500. In another embodiment, the memory controller 300 may utilize non-usage-based replacement algorithm (e.g., FIFO, random) when moving data between the first-type memory 500 and the second-type memory 600.

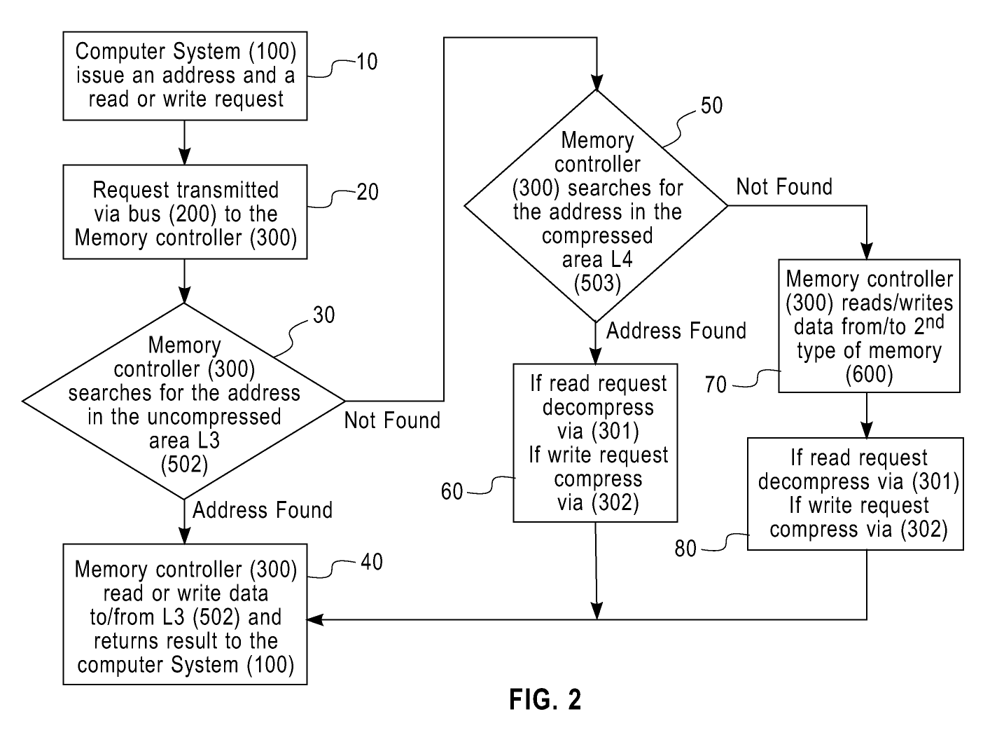

FIG. 2 depicts a flow chart depicting steps involved for performing a read and write operation of the present invention. At step 10, the computer system 100 issues an address and a data read or data write request. At step 20, the data read or data write request is transmitted from the computer system 100 to the memory controller 300 via an address/data bus 200. At step 30, the memory controller 300 searches the issued address location in the uncompressed data region 502 (L3) of the first-type memory 500. At step 40, if the address is found in the uncompressed data region 502 (L3) of the first-type memory 500, in case of the read request, the memory controller 300 reads uncompressed data from a memory location specified by the address and returns the data to the computer system 100. If the address is found in the uncompressed data region 502 (L3) of the first-type memory 500, in case of the write request, the memory controller 300 writes uncompressed data into the memory location specified by the address. If the issued address is not found in the uncompressed data region 502 (L3) of the first-type memory 500, at step 50, the memory controller 300 searches the address in the compressed data region 503 (L4) of the first-type memory 500. If the address is found in the compressed data region 503 (L4), at step 60, in case of the read request, the data found in the address is retrieved and decompressed by the decompressor 301 of the memory controller 300. The decompressed data is then written to an available memory location in the uncompressed data region 502 (L3) with the address and then provided to the computer system 100. In one embodiment, the memory controller 300 writes the uncompressed data in the uncompressed data region 502 (L3) and provides the uncompressed data to the computer system 100 simultaneously. If the address is found in the compressed data region 503 (L4), at step 60, in case of the write request, data is compressed and written to the memory location (i.e., a memory location in L4) specified by the address. At the same time, the data, which is not compressed, is written to an available memory location in the uncompressed data region 502 (L3) with the address. When there is no available space in the uncompressed data region 502 (L3), some or all data in the uncompressed data region 502 (L3) are written in the compressed data region 503 (L4) to make available space in the uncompressed data region 502 (L3). The data in the uncompressed data region 502 (L3) are compressed before being written in the compressed data region 503 (L4). In the absence of available space in the first-type memory 500 (L3 and L4), some or all data in the first-type memory 500 is written in the second-type memory 600 (L5), after being compressed, to make available space in the first-type memory 500.

Returning to step 50 in FIG. 2, if the issued address is not found in the uncompressed data region 502 (L3) and the compressed data region 503 (L4), the memory controller 300, at step 70, searches the second-type memory 600 (L5). If the address is found in the second-type memory 600 (L5), the memory controller 300 reads/writes data from/into the memory location specified by the address. In addition, in the case of the read request, data in the memory location is decompressed via the decompressor 301 of the memory controller 300. The uncompressed data is written to an available memory location in the uncompressed data region 502 (L3) with the address and transferred to the computer system 100. At the same time, the compressed data, which is retrieved from the second-type memory 600 (L5), is written to an available memory location in the compressed data region 503 (L4) with the address. In one embodiment, writing the uncompressed data in the uncompressed data region 502 (L3) and transferring the uncompressed data to the computer system 100 occur simultaneously (i.e., are performed at the same time). In the case of the write request, data is compressed via the compressor 302 of the memory controller 300. The compressed data is written to the memory location (i.e., in the second-type memory 600 (L5)) specified by the address. At the same time, the original data, which is not compressed, is written to an available memory location in the uncompressed data region 502 (L3) with the address and the compressed data is written to an available memory location in the compressed data region 503 (L4) with the address.

In one embodiment, the prevent invention utilizes a “write-back” scheme and a “write-through” scheme between the uncompressed data region (L3), the compressed data region (L4), and the second-type memory 600 (L5). “Write-back” scheme means when the memory controller 300 writes data to a memory location that is currently held in uncompressed data region 502 (L3), the memory controller writes the data only in the memory location in the uncompressed data region 502 (L3). When the memory location in the uncompressed data region 502 (L3) is needed for another memory address, the data (i.e., in the memory location in the uncompressed data region 502 (L3)) is written to the compressed data region 503 (L4) and to the second-type memory 600 (L5). “Write-through” scheme means when the memory controller 300 writes data to a memory location that is currently held in uncompressed data region 502 (L3) of the first-type of memory 500, the memory controller 300 additionally writes the data in a corresponding memory location in the compressed data region 503 (L4) of the first-type memory 500 and the corresponding memory location in the second-type memory 600 (L5).

In another embodiment, upon receiving a memory access request from the computer system 100, the memory controller 300 may access the uncompressed data region 502 (L3), the compressed data region 503 (L4), and the second-type memory 600 (L5) at same time to search an address provided by the computer system 100. The uncompressed data region 502 (L3) may have fastest data retrieval time among the uncompressed data region 502 (L3), the compressed data region 503 (L4), and the second-type memory 600 (L5). The second-type memory 600 (L5) may have slowest data retrieval time among the uncompressed data region 502 (L3), the compressed data region 503 (L4), and the second-type memory 600 (L5).

In one embodiment, the present invention further includes cache memories such as a level 1 SRAM cache or a level 2 SRAM cache. Therefore, the present invention may have a memory hierarchy that comprises a level 1 SRAM cache (top layer), a level 2 SRAM cache (a second layer), a uncompressed data region in a DRAM, a compressed data region in the DRAM, and a flash memory (bottom).

While the invention has been described with respect to a limited number of embodiments, it will be appreciated that many variations, modifications and other applications of the invention may be made.

What is claimed is:

1. A computer memory system having a multi-level hierarchical memory structure, the computer memory system comprising:
a first-type memory being a volatile memory and having a uncompressed data region (L3) and a compressed data region (L4);
a second-type memory (L5) being an non-volatile memory, being slower than the first-type memory, having more capacity than the first-type memory, and storing compressed data; and
a memory controller means for controlling a direct I/O access to the first-type memory and the second-type memory, for controlling data exchange between the first-type memory and the second-type memory (L5) in response to an issuance of a memory access request from a general purpose processor, and for controlling data exchange between the uncompressed data region (L3) and the compressed data region (L4) in the first-type memory according to an issuance of a memory accesses request from the general purpose processor.

2. The computer memory system according to claim 1, wherein
the first-type memory is one of: Dynamic Random Access Memory (DRAM) and Static Random Access Memory (SRAM); and
the second-type memory is one of: NAND-based flash memory, NOR-based flash memory, Phase Change Memory (PCM), Ferroelectric RAM (FeRAM), and Magnetoresistive RAM (MRAM).

3. The computer memory system according to claim 1, wherein a size of the compressed data region (L4) and a size of the uncompressed data region (L3) are fixed.

4. The computer memory system according to claim 1, wherein a size of the compressed data region (L4) and a size of the uncompressed data region (L3) are dynamically adjusted based on a compressibility of data in the first-type memory.

5. The computer memory system according to claim 1, wherein the uncompressed data region (L3) contains a cached copy of a portion of data in the compressed data region (L4).

6. The computer memory system according to claim 4, wherein data in the uncompressed data region (L3), in the absence of available space in the uncompressed data region (L3), are written to the compressed data region (L4) to make available space in the uncompressed data region (L3) after being compressed.

7. The computer memory system according to claim 4, wherein if an address of data requested by a general purpose processor is absent in the uncompressed data region (L3), then the data is retrieved from the uncompressed data region (L4) and the data retrieved from the compress data region (L4) is decompressed and written to the uncompressed data region (L3).

8. The computer memory system according to claim 1, wherein if an address of data requested by a general purpose processor is absent in the uncompressed data region (L3) and in compressed data region (N), then the data is retrieved from the second-type memory (L5) and the data retrieved from the second-type memory is decompressed and written to the uncompressed data region (L3).

9. The computer memory system according to claim 1, wherein the first-type memory contains a cached copy of a portion of the second-type memory (L5).

10. The computer memory system according to claim 1, wherein data in the first-type memory (L3 and L4), in the absence of available space, are written to the second-type memory (L5) to make available space in the first-type memory (L3 and L4).

11. The computer memory system according to claim 1, further comprising:
a multi-processor being connected to the computer memory system via one of: Hyper Transport physical link, PCI express, InfiniBand, an industry standard, and a non-industry standard link;
a circuit carrier or a printed circuit board attaching the multi-processor, the first-type memory, the second-type memory, and the memory controller means and occupying at least one processor socket for the multi-processor, the multi-processor is one of: Symmetric Multi-Processor and Heterogeneous Multi-Processor; and
a memory module encapsulating the first-type memory, the second-type memory, and the memory controller means and being plugged in the circuit carrier or the printed circuit board, the memory module is one of: Dual In-line Memory Module (DIMM) and Single In-line Memory Module (SIMM).
